(19) United States
(12) Patent Application Publication
(10) Pub. No.: US 2015/0278180 A1
(43) Pub. Date: Oct. 1, 2015

(54) SYSTEM AND METHOD FOR ANNOTATING WEBPAGES

(71) Applicant: Project T, LLC, Dallas, TX (US)

(72) Inventors: George Francis Nicholas, JR., Dallas, TX (US); Stephen Joshua Parish, Plano, TX (US); Judd Daniel Cobler, Plano, TX (US)

(73) Assignee: Project T, LLC, Dallas, TX (US)

(21) Appl. No.: 14/242,517

(22) Filed: Apr. 1, 2014

(51) Int. Cl. G06F 17/24; G06F 3/0484

(52) U.S. Cl. CPC G06F 17/241; G06F 3/04847

(57) ABSTRACT

A system and method for annotating webpages including a method of annotating webpages from a personal device by opening a web browser on the personal device, the web browser including a commentary service Web Edit button; opening a website in the web browser; actuating the commentary service Web Edit button: to automatically capture a screenshot of the opened website, to open a commentary service browser window in the web browser, (the commentary service browser window including editing tools and a commentary service Web Publish button), and to display the automatically captured screenshot in the opened commentary service browser window; editing the screenshot with the editing tools within the commentary service browser window to generate an edited screenshot; and actuating the commentary service Web Publish button to save the edited screenshot associated with the website to commentary service remote storage.

### TECHNICAL FIELD

The technical field of this disclosure is web browsers and documents displayed on such web browsers, particularly, systems and methods for annotating webpages.

### BACKGROUND OF THE INVENTION

Social media, such as Facebook and Twitter, allow people to interact to create, share, and exchange information and ideas. Although the interaction can include images to greatly enhance the interaction, the interaction remains primarily text based. Handling of the images within social media is limited. In one case, users can post a URL link on their social media account to allow other users to go to the same website that they are seeing in view images that they are seeing. In another case, users can upload image files stored locally on their personal computer. Unfortunately, users cannot easily browse the World Wide Web, comment on any images they may run across, and post the image with comments to their social media account.

It would be desirable to have a system and method for annotating webpages that would overcome the above disadvantages.

### SUMMARY OF THE INVENTION

One aspect of the present invention provides a method of annotating webpages from a personal device including opening a web browser on the personal device, the web browser including a commentary service Web Edit button; opening a website in the web browser; actuating the commentary service Web Edit button: to automatically capture a screenshot of the opened website, to open a commentary service browser window in the web browser (the commentary service browser window including editing tools and a commentary service Web Publish button), and to display the automatically captured screenshot in the opened commentary service browser window; editing the screenshot with the editing tools within the commentary service browser window to generate an edited screenshot; and actuating the commentary service Web Publish button to save the edited screenshot associated with the website to commentary service remote storage, the commentary service remote storage being remote from the personal device.

Another aspect of the present invention provides a device for annotating webpages with user input including a user interface for receiving the user input; a processor coupled to the user interface; and a memory coupled to the processor. The memory contains programming code responsive to the user input to the user interface to: open a web browser, the web browser including a commentary service Web Edit button; open a website in the web browser; automatically capture a screenshot of the opened website when the user input is actuation of the commentary service Web Edit button; open a commentary service browser window in the web browser when the user input is the actuation of the commentary service Web Edit button, the commentary service browser window including editing tools and a commentary service Web Publish button; display the automatically captured screenshot in the opened commentary service browser window when the user input is the actuation of the commentary service Web Edit button; edit the screenshot with the editing tools within the commentary service browser window to generate an edited screenshot; and save the edited screenshot associated with the website to commentary service remote storage when the user input is actuation of the commentary service Web Publish button, the commentary service remote storage being remote from the device.

Yet another aspect of the present invention provides a system for annotating webpages including commentary service remote storage; and a personal device having a user interface to receive user input and being operably connected to communicate with the commentary service remote storage, the commentary service remote storage being remote from the personal device. The personal device is responsive to the user input to: open a web browser, the web browser including a commentary service Web Edit button; open a website in the web browser; automatically capture a screenshot of the opened website when the user input is actuation of the commentary service Web Edit button; open a commentary service browser window in the web browser when the user input is the actuation of the commentary service Web Edit button, the commentary service browser window including editing tools and a commentary service Web Publish button; display the automatically captured screenshot in the opened commentary service browser window when the user input is the actuation of the commentary service Web Edit button; edit the screenshot with the editing tools within the commentary service browser window to generate an edited screenshot; and save the edited screenshot associated with the website to the commentary service remote storage when the user input is actuation of the commentary service Web Publish button.

The foregoing and other features and advantages of the invention will become further apparent from the following detailed description of the presently preferred embodiment, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a block diagram of a system for annotating webpages in accordance with one embodiment of the present invention.

FIG. 2 is a user interface of web content displayed in a web browser of a personal device in accordance with the present invention.

FIG. 3 is a detail of a user interface of a commentary service add-in button with a drop-down box displayed in a web browser of a personal device in accordance with the present invention.

FIG. 4 is a user interface of a captured screenshot displayed in a commentary service browser window of a personal device in accordance with the present invention.

FIGS. 5A-5F are details of editing tools for use with a captured screenshot displayed in a commentary service browser window of a personal device in accordance with the present invention.

FIG. 6 is a user interface of a captured screenshot with annotations displayed in a commentary service browser window of a personal device in accordance with the present invention.

FIGS. 7A-7C are publication options screens displayed in a commentary service browser window of a personal device in accordance with the present invention.

FIG. 8 is a user interface of a confirmation screen displayed in a commentary service browser window of a personal device in accordance with the present invention.

FIGS. 9A & 9B are a user interface of a commentary service post screen and attribution detail view, respectively, displayed in a commentary service browser window of a personal device in accordance with the present invention.

FIG. 10 is a user interface of a user editing screen displayed in a commentary service browser window of a personal device in accordance with the present invention.

FIG. 11 is a user interface of a user home screen displayed in a commentary service browser window of a personal device in accordance with the present invention.

FIG. 12 is a user interface detail view of a drop-down index box displayed in a commentary service browser window of a personal device in accordance with the present invention.

FIG. 13 is a user interface of a single edited screenshot screen displayed in a commentary service browser window of a personal device in accordance with the present invention.

FIG. 14 is a user interface of a tag search results screen displayed in a commentary service browser window of a personal device in accordance with the present invention.

FIGS. 15A & 15B are a user interface of a user profile screen and a user profile edit screen, respectively, displayed in a commentary service browser window of a personal device in accordance with the present invention.

FIG. 16 is a user interface of an explore screen displayed in a commentary service browser window of a personal device in accordance with the present invention.

FIG. 17 is a user interface of user account drop-down list displayed in a commentary service browser window of a personal device in accordance with the present invention.

FIG. 18 is a user interface of user account history screen displayed in a commentary service browser window of a personal device in accordance with the present invention.

FIGS. 19A & 19B are a user interface of an earned accomplishments tab and a potential accomplishments tab, respectively, of a user account profile screen displayed in a commentary service browser window of a personal device in accordance with the present invention.

FIGS. 20A-20C are user interfaces of a website displayed in a web browser of a personal device in accordance with the present invention.

FIGS. 21A & 21B are a user interface of an edited screenshot screen displayed in a web browser of a personal device in accordance with the present invention.

FIG. 22 is a flowchart for a method of annotating webpages in accordance with one embodiment of the present invention.

Throughout the various figures, like reference numbers refer to like elements.

### DETAILED DESCRIPTION OF PRESENTLY PREFERRED EMBODIMENTS

The present invention provides a commentary service which can be used to automatically capture a screenshot of a website, edit the screenshot, and store the edited screenshot and remote storage associated with the commentary service. When a website associated with an edited screenshot is open, the user can retrieve the edited screenshot from the remote storage for display. Users can also add comments to the edited screenshot.

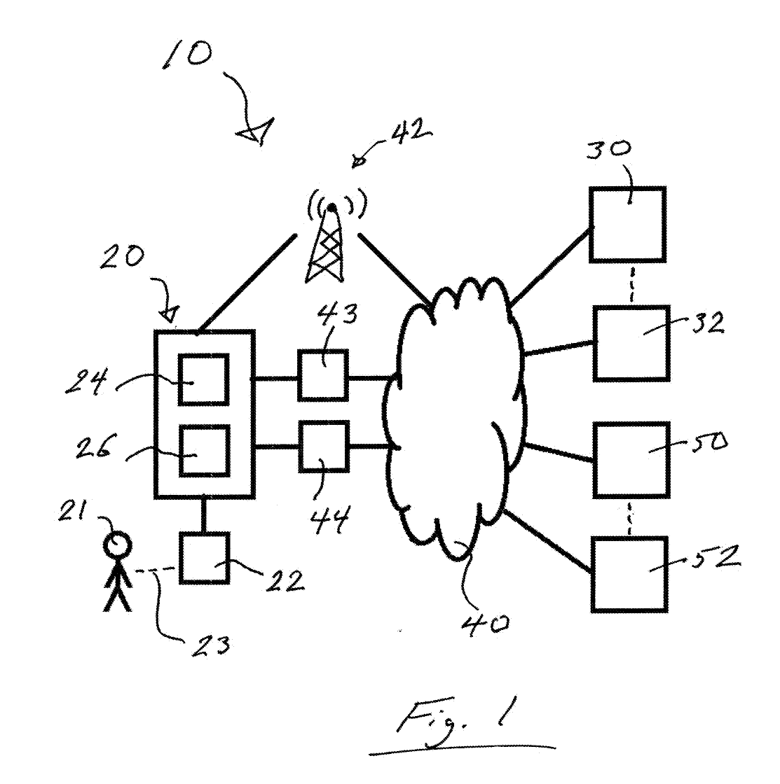

FIG. 1 is a block diagram of a system for annotating webpages in accordance with one embodiment of the present invention. The system 10 includes a personal device 20 and commentary service remote storage 30. The personal device 20 can have a user interface 22 to receive user input 23 from a user 21 and can be operably connected to communicate with the commentary service remote storage 30. Exemplary personal devices 20 include personal computers, tablet computers, portable computers, smart phones, and the like. The user interface 22 can be any user interface operable to display graphical information and to receive input from a user, such as a computer screen/mouse/keyboard combination on a personal computer, a touch screen on a tablet computer or smart phone, or the like. The personal device 20 can also include a processor 24 coupled to the user interface 22 and memory 26 coupled to the processor 24. The memory 26 can contain programming code responsive to the user input 23 to the user interface 22 to carry out a method of annotating webpages from the personal device 20.

In one embodiment, the personal device 20 communicates with the commentary service remote storage 30 over the Internet 40. The personal device 20 can be connected to the Internet 40 through a cellular system 42, a Wi-Fi node 43, a DSL modem 44, or the like. The system 10 can also include a commentary service hardware server 32 operably connected to communicate with the commentary service remote storage 30 and other parts of the system 10 over the Internet 40 and/or directly. The system 10 can also include third-party servers 50 and third-party storage 52 connected to communicate with other parts of the system 10 over the Internet 40 and/or directly. Although illustrated as single components, the various components of the system 10 can be distributed as a number of components to provide the desired functionality, capacity, and capability desired for a particular application. The system 10 can include additional memory and/or hardware servers to store data and computer code, processors to carry out instructions of the computer code, and communication hardware/software as required to carry out a method of annotating webpages from a personal device. Those skilled in the art will appreciate that the system 10 is an example and that any number of other communication configurations can be used to carry out the method of annotating webpages from a personal device described.

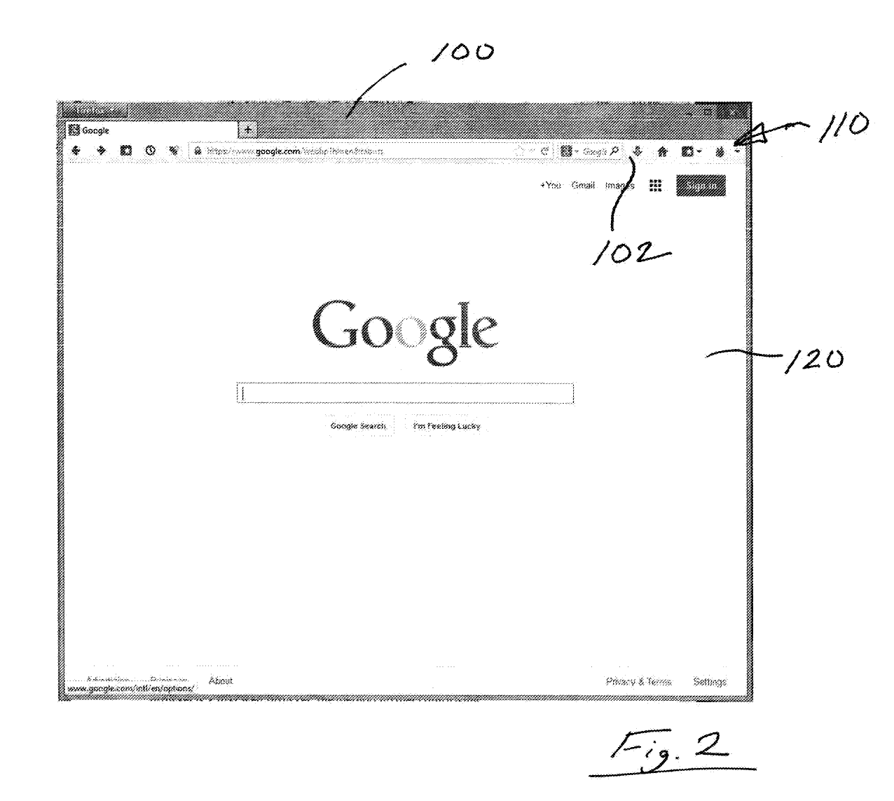

FIG. 2 is a user interface of web content displayed in a web browser of a personal device in accordance with the present invention. In this example, the web browser 100 is the Firefox web browser open on a personal device (not shown). A commentary service add-in button 110 is displayed on the navigation toolbar 102 of the web browser 100. The web content 120 in this example is the homepage for the Google website at www.Google.com. Those skilled in the art will appreciate that the web browser can be any software application operable to retrieve and present information resources written in HTML or other markup language on the World Wide Web, private network Web servers, file systems, or the like. Exemplary web browsers include Google Chrome, Mozilla Firefox, Internet Explorer, Opera, and Safari.

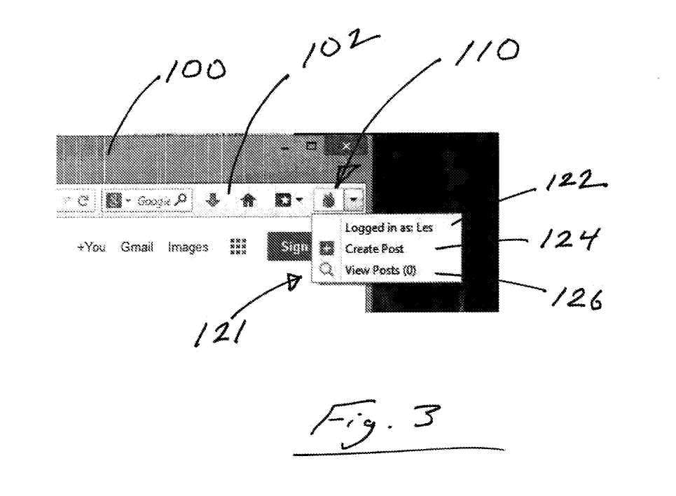

FIG. 3 is a detail of a user interface of a commentary service add-in button with a drop-down box displayed in a web browser of a personal device in accordance with the present invention. In this embodiment, actuation of the commentary service add-in button 110 displays a drop-down box 121 including commentary service login button 122, a commentary service Web Edit button 124, and a commentary service Show Annotation button 126. The commentary service Web Edit button 124, when actuated, captures a screenshot of the web content 120, opens a commentary service browser window in the web browser 100, and displays the screenshot in the commentary service browser window. The commentary service login button 122 can include user identity information to indicate the name of the user who is logged in to the commentary service and, when actuated, can display the commentary service home page of the user in the web browser 100. The commentary service Show Annotation button 126 can include an indication of the number of edited screenshots associated with the website 120 and, when actuated, can retrieve one or more of the edited screenshots from commentary service remote storage and display one or more of the edited screenshots in the web browser 100. Those skilled in the art will appreciate that the drop-down box 121 can include any buttons or information desired for a particular application.

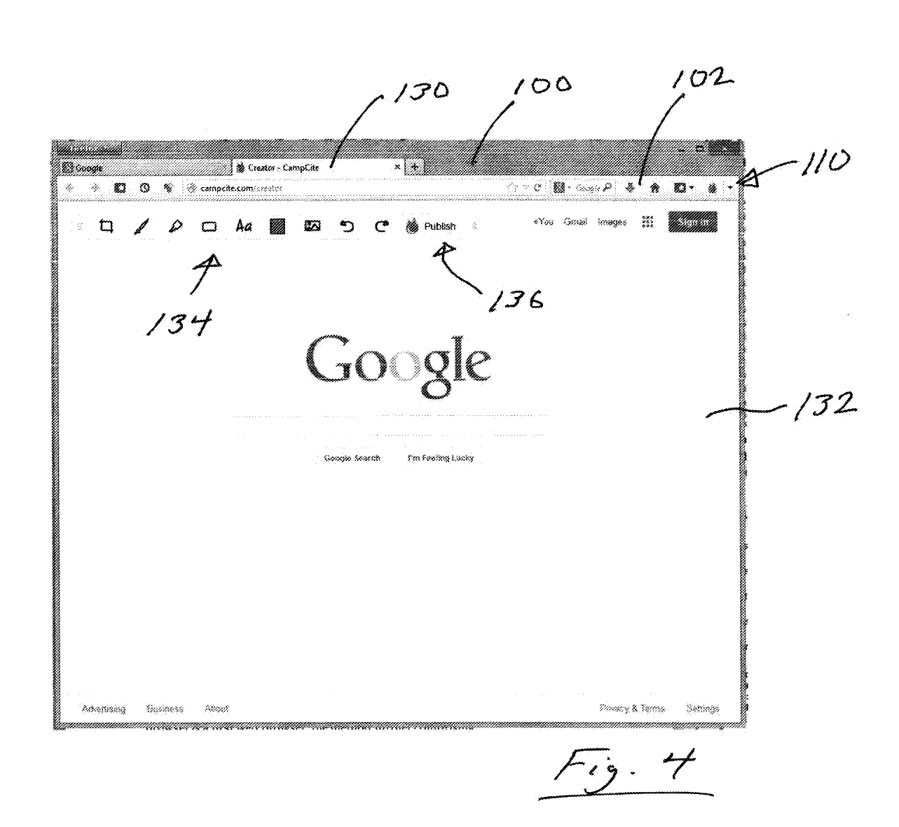

FIG. 4 is a user interface of a captured screenshot displayed in a commentary service browser window of a personal device in accordance with the present invention. The captured screenshot 132 automatically appears in the commentary service browser window 130 in the web browser 100 when the commentary service Web Edit button (not shown) is actuated. The commentary service browser window includes editing tools 134, which can be used to edit the captured screenshot 132, and a commentary service Web Publish button 136, which can be used to save the edited screenshot associated with the website to commentary service remote storage. In this example, the commentary service browser window 130 is displayed as a tab within the web browser 100. In another example, the commentary service browser window can open as a separate window on the personal device.

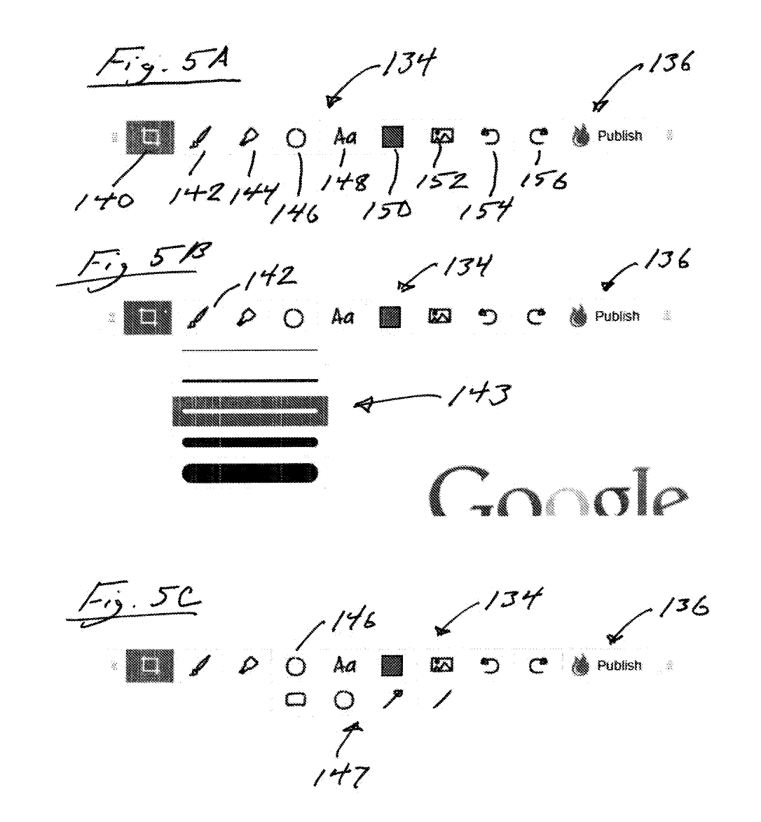

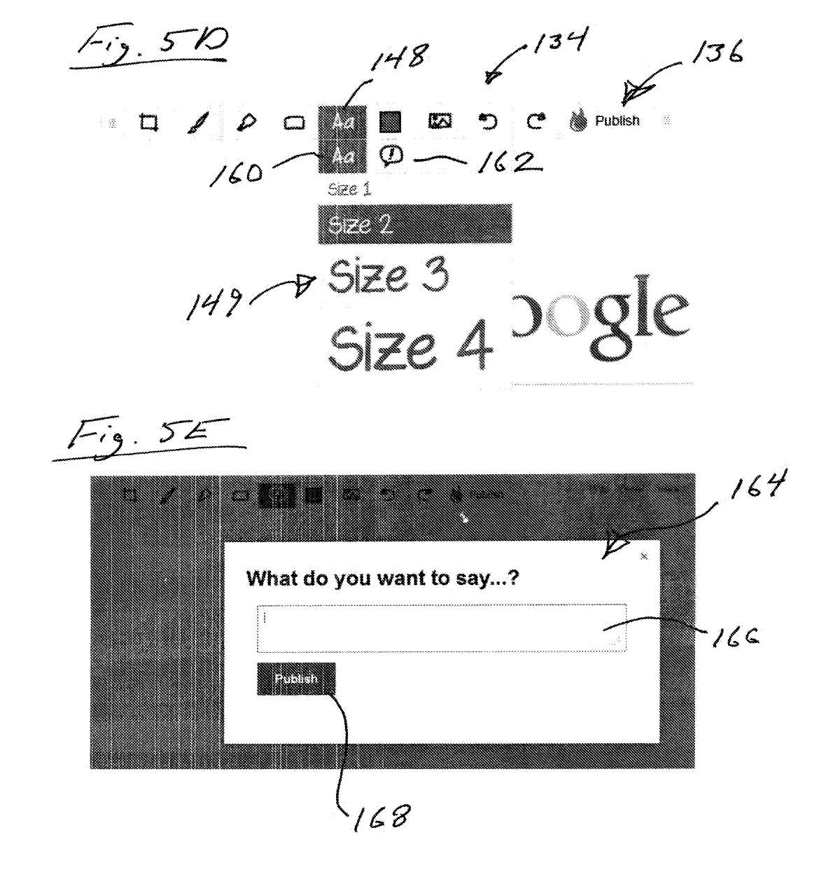

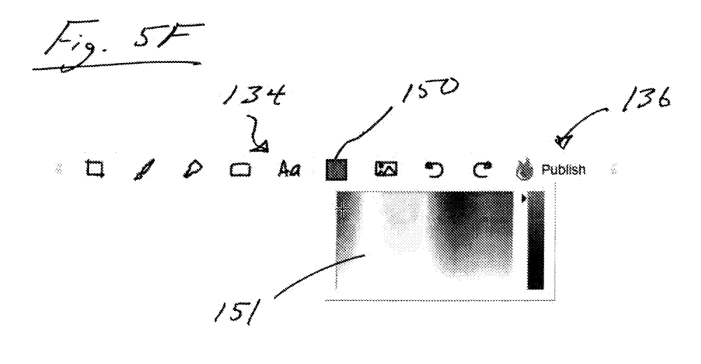

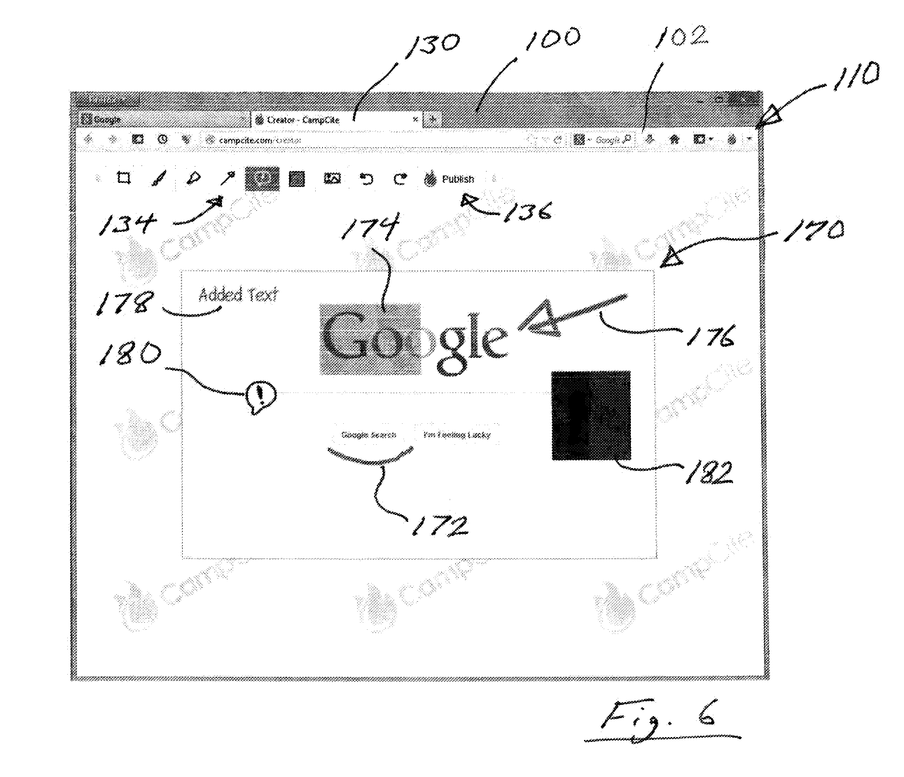

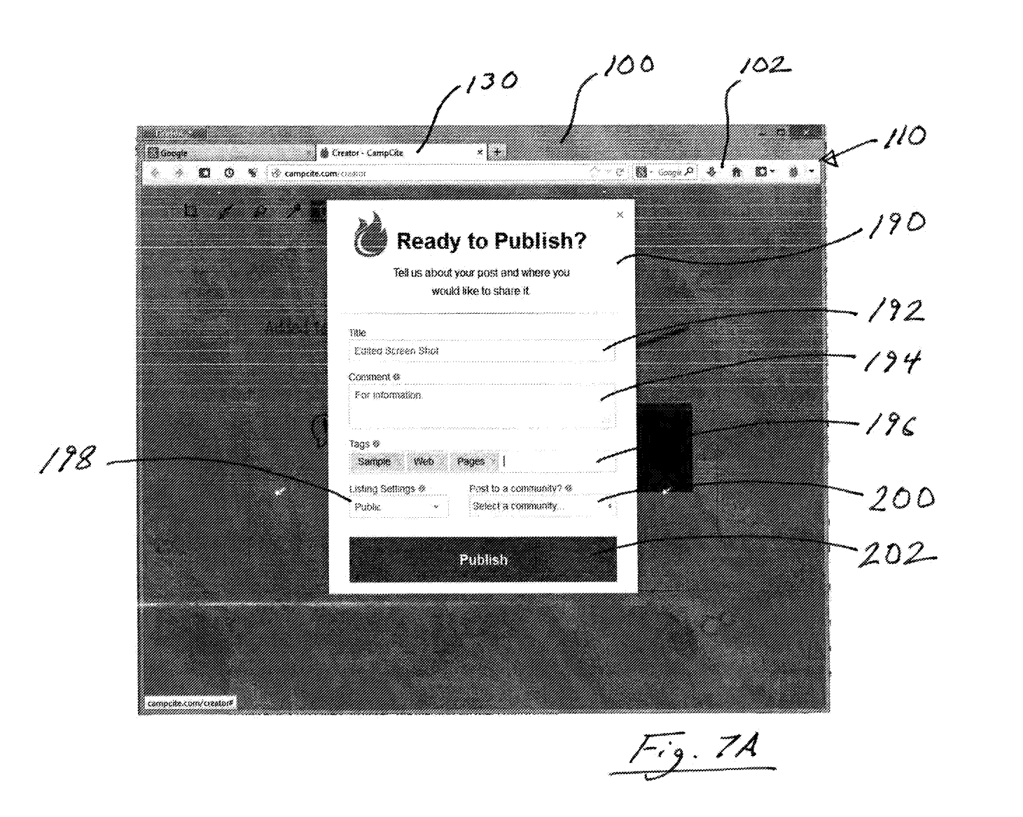

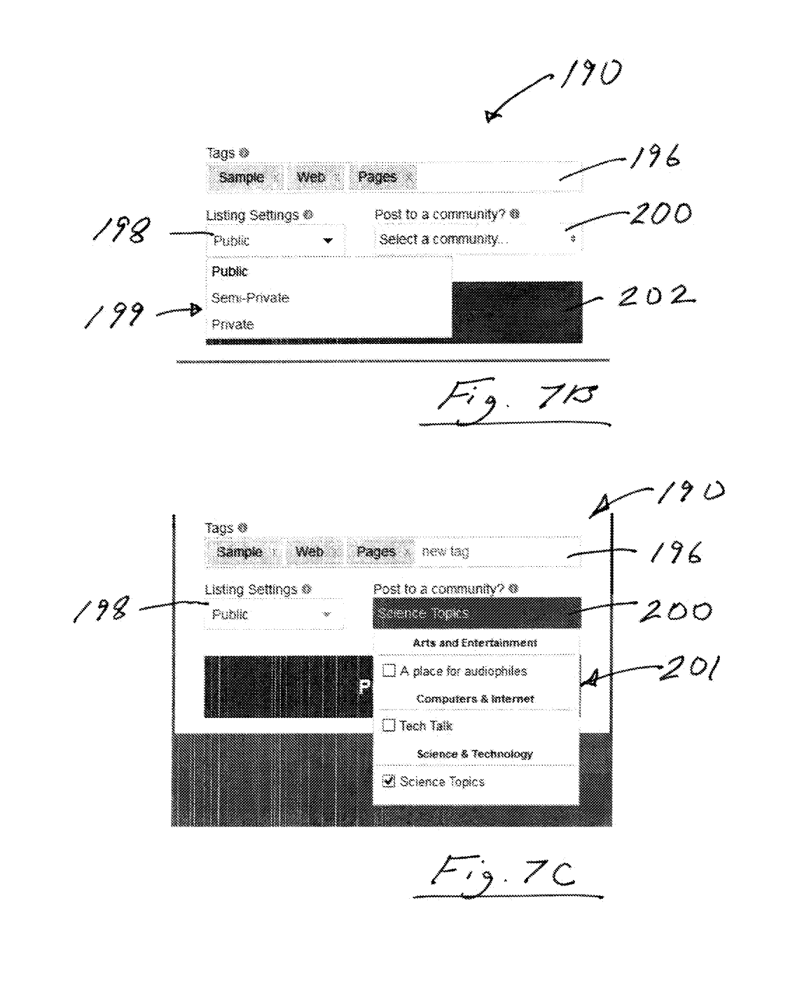

FIGS. 5A-5F are details of editing tools for use with a captured screenshot displayed in a commentary service browser window of a personal device in accordance with the present invention.

Referring to FIG. 5A, the editing tools 134 include a cropping tool 140, pen tool 142, highlight tool 144, figure tool 146, text tool 148, color selection tool 150, image selection tool 152, reverse action tool 154, and repeat action tool 156. The cropping tool 140 allows selection of a portion of the captured screenshot and cropping to the selected portion. The highlight tool 144 allows semi-transparent color highlighting the portion of the captured screenshot. The image selection tool 152 allows a graphic image from a file on the personal device to be embedded in the captured screenshot. The reverse action tool 154 allows reversal of the prior editing action and the repeat action tool 156 allows restoration of a previously reversed editing action.

Referring to FIG. 5B, the pen tool 142 allows freehand line drawings to be added to the captured screenshot. Hovering the mouse pointer over the pen tool 142 displays a line width option drop-down box 143, from which a particular line width can be selected using the mouse pointer.

Referring to FIG. 5C, the figure tool 146 allows pre-configured geometric figures to be added to the captured screenshot. Hovering the mouse pointer over the figure tool 146 displays a geometric figure option drop-down box 147, from which a particular geometric figure, such as a box, circle, arrow, or line, can be selected using the mouse pointer.

Referring to FIG. 5D, the text tool 148 allows user selected text to be added to the captured screenshot. Hovering the mouse pointer over the text tool 148 displays a text size option drop-down box 147, from which a particular text size can be selected using the mouse pointer. Hovering the mouse pointer over the text tool 148 also displays a hidden comment box tool 162, which opens a text input box when selected with the mouse pointer. Referring to FIG. 5E, the text input box 164 opens in front of the captured screenshot, and includes a text input box 166 and the publication button 168. The user can enter text in the text input box 166 and actuate the publication button 168 to annotate the captured screenshot with hidden text. A hidden text indicator is displayed on the captured screenshot and the associated hidden text is displayed when the mouse pointer hovers over the hidden text indicator.

Referring to FIG. 5F, the color selection tool 150 allows a particular color to be used in the other editing tools, such as the pen tool 142, highlight tool 144, figure tool 146, and text tool 148, for example. Hovering the mouse pointer over the color selection tool 150 displays a color selection drop-down box 151, from which a particular color can be selected using the mouse pointer.

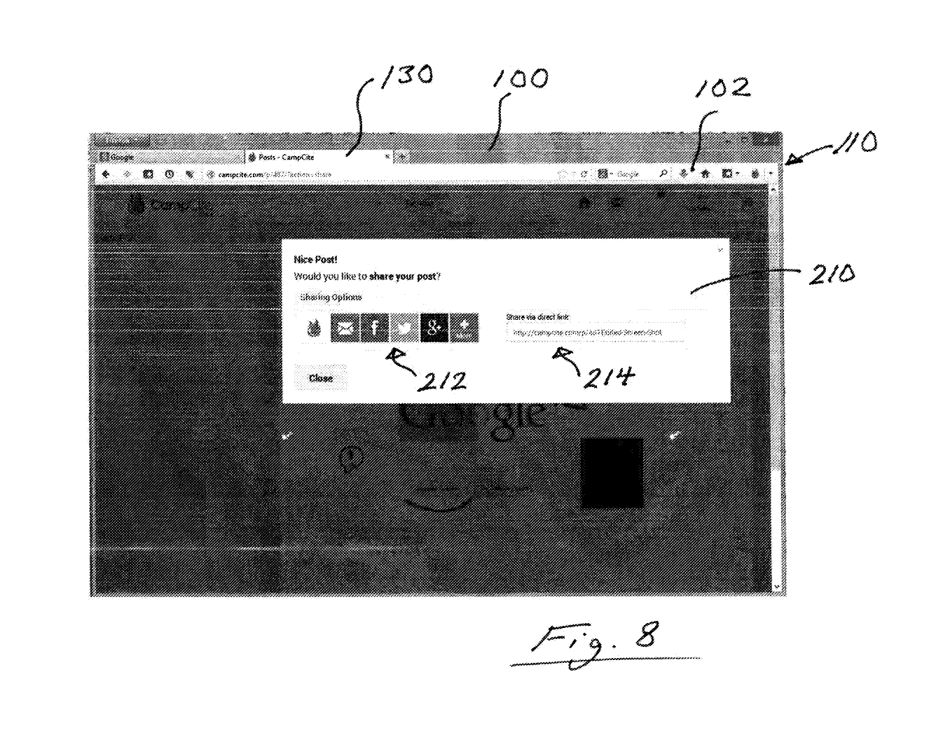

FIG. 6 is a user interface of a captured screenshot with annotations displayed in a commentary service browser window of a personal device in accordance with the present invention. The captured screenshot has been annotated into the edited screenshot 170 with the editing tools 134. A portion of the captured screenshot has been cropped to the edited screenshot 170 through the use of the cropping tool. A freehand curve 172 has been added with the pen tool 142. A highlight 174 has been added with the highlight tool. A geometric FIG. 176, in this example an arrow, has been added with the figure tool. Text 178 has been added with the text tool. A hidden text indicator 180 has been added with the hidden comment box tool, so that hovering the mouse pointer over the hidden text indicator 180 will display text attached to the edited screenshot 170, but not shown. A graphic image 182 from a file on the personal device has been added with the image selection tool. The commentary service Web publish button 136, when actuated, saves the edited screenshot 170 associated with the website to commentary service remote storage.

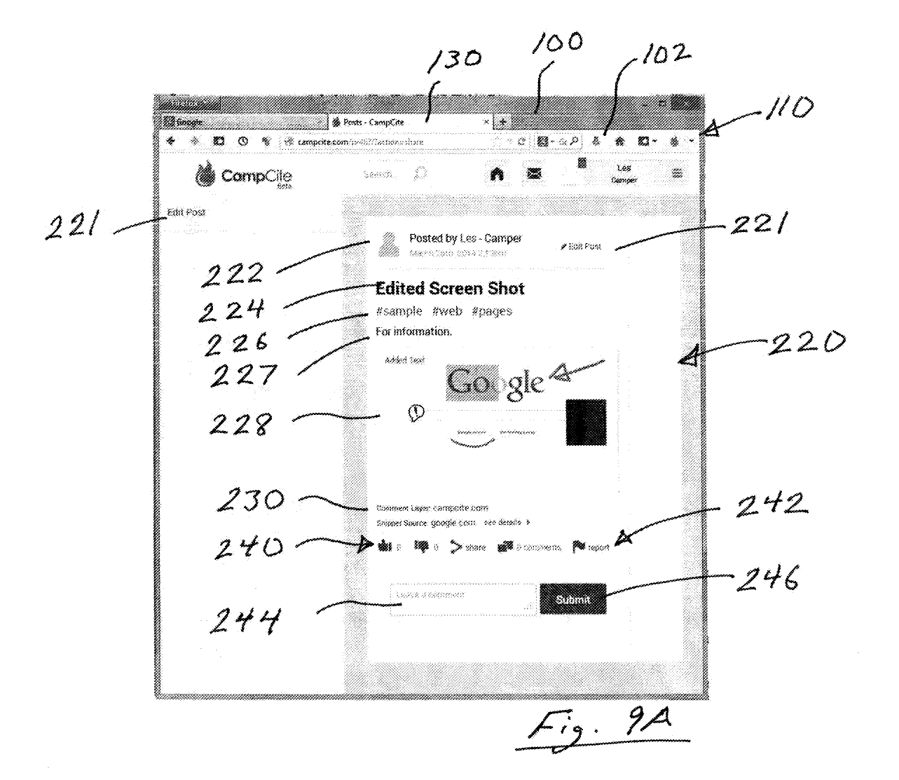

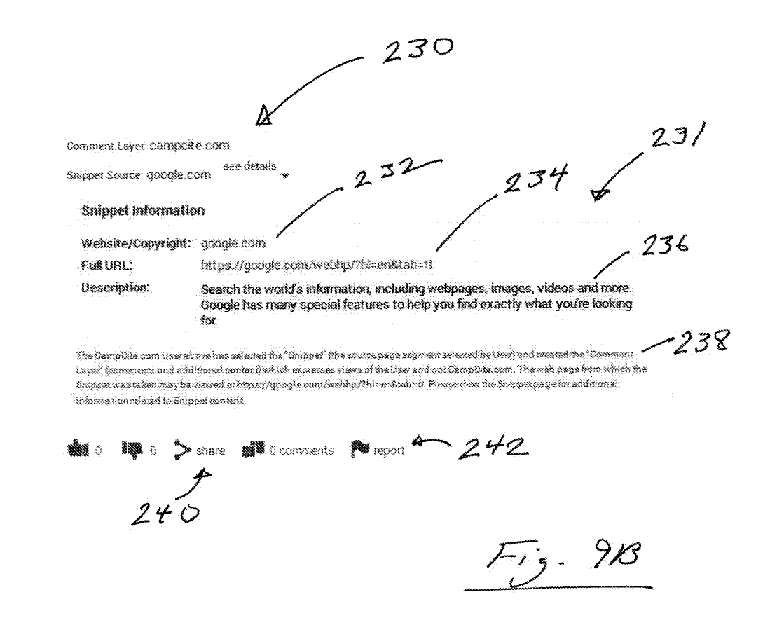

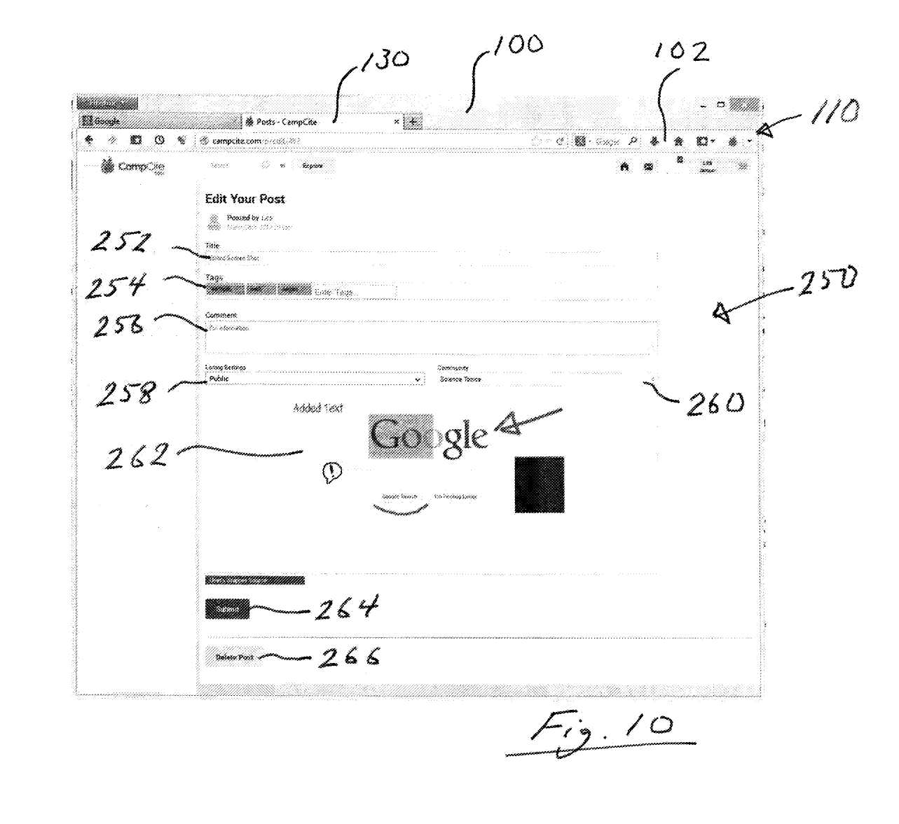

FIGS. 7A-7C are publication options screens displayed in a commentary service browser window of a personal device in accordance with the present invention. In this embodiment, actuating the commentary service Web publish button opens the publication options screen 190 as an overlay on the commentary service browser window 130. In another embodiment, actuating the commentary service Web publish button automatically saves the edited screenshot 170 associated with the website to commentary service remote storage in accordance with predetermined parameters.

Referring to FIG. 7A, the publication options screen 190 can include fillable information fields for the user to enter information to be associated with the edited screenshot. The publication options screen 190 can include a title field 192 for titling the edited screenshot, a comment post field 194 for the posting user to add comments related to the edited screenshot, and a tag field 196 for entering tags to be used in indexing the edited screenshot. Referring to FIG. 7B, the publication options screen 190 can also include a listing settings box 198 including a pulldown menu 199 which determines the accessibility of the edited screenshot, i.e., whether the edited screenshot is to be public, semi-private (available to selected users), or private (available only to the user creating the edited screenshot). Referring to FIG. 7C, the publication options screen 190 can also include a community selection box 201 which allows the user to determine in which communities within the commentary service the edited screenshot is to be posted.

Referring to FIG. 7A, the publication options screen 190 can also include a final publication button 202 which, when actuated, saves the edited screenshot associated with the website to commentary service remote storage after the user has completed the desired fillable information fields on the publication options screen 190.

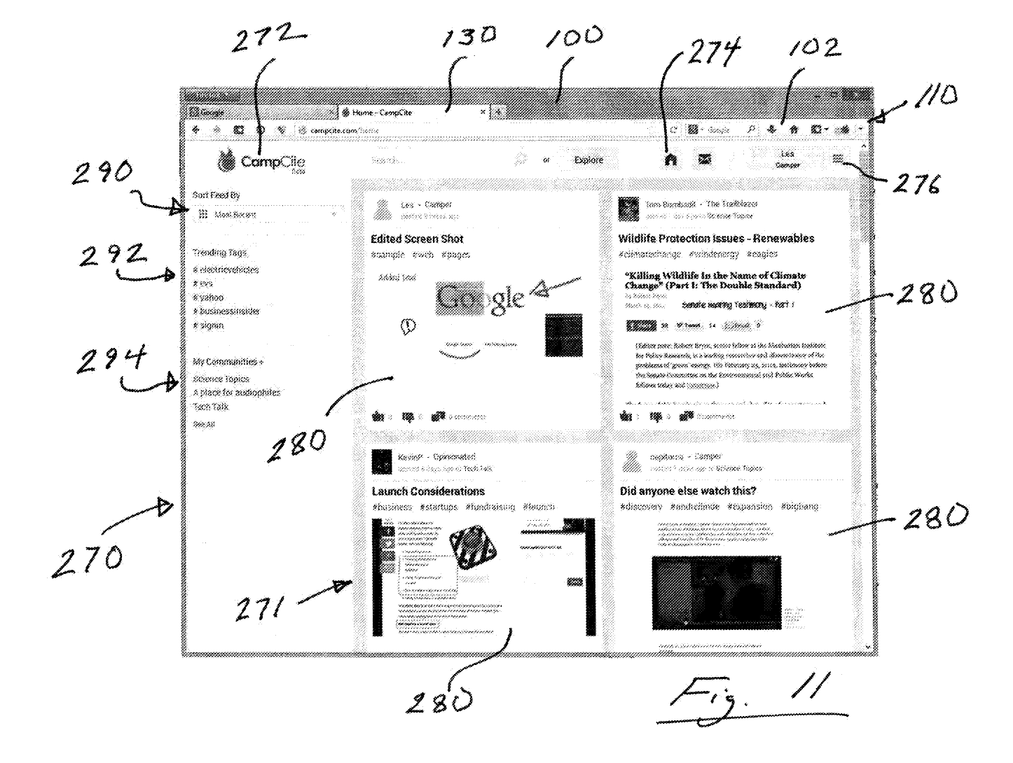

FIG. 8 is a user interface of a confirmation screen displayed in a commentary service browser window of a personal device in accordance with the present invention. In one embodiment, actuating the final publication button can display a confirmation screen 210. The confirmation screen 210 can also include social media buttons 212, which can further publish the edited screenshot to other social media sites, such as Facebook, Twitter, Google Plus, or the like. The confirmation screen 210 can also include a share button 214, which in one embodiment can e-mail the web link of the saved edited screenshot (i.e., the URL for the saved edited screenshot stored on the commentary service remote storage) to other users, or which in another embodiment can e-mail the web link of the saved edited screenshot to the user himself for forwarding to other parties.

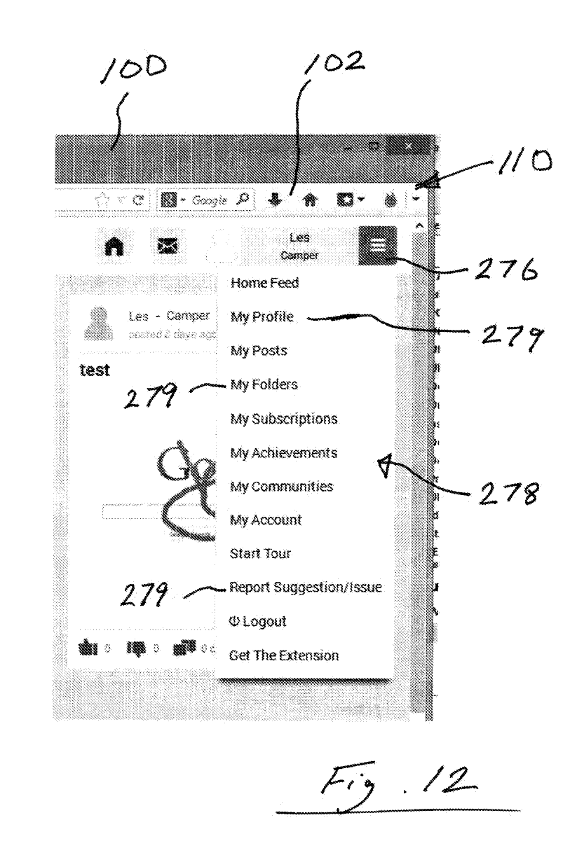

FIGS. 9A & 9B are a user interface of a commentary service post screen and attribution detail view, respectively, displayed in a commentary service browser window of a personal device in accordance with the present invention.

Referring to FIG. 9A, the edited screenshot as-posted screen 220 can be displayed in a commentary service browser window of a personal device when the close button on the confirmation screen is actuated. The edited screenshot as-posted screen 220 can include a user identifier 222, an edited screenshot title 224, edited screenshot tag buttons 226 (searchable by clicking on a particular tag), an edited screenshot comment post 227, an edited screenshot image 228, edited screenshot attributions 230, edited screenshot popularity markers 240 (indicating a number of popularity votes, linking, comments, or the like), edited screenshot report button 242 (allowing any user to report unlawful activity, trademark problems, spam, or the like within the edited screenshot), a user comment field 244, and a user comment submit button 246 (allowing any user to post user comments about the edited screenshot). The edited screenshot as-posted screen 220 can also include one or more edit post buttons 221, which allows the user to open a post editing screen.

Referring to FIG. 9B, the attribution detail 231 appears on the edited screenshot as-posted screen 220 when actuating a detail button associated with the edited screenshot attributions 230. The attribution detail 231 can include an originating website name 232, an originating website URL 234, and an originating website description 236, all for the website from which the edited screenshot originated. The attribution detail 231 can also include construction information 258 explaining that the user selects the source page segment and creates comments and additional content which express views of the user and not the commentary service.

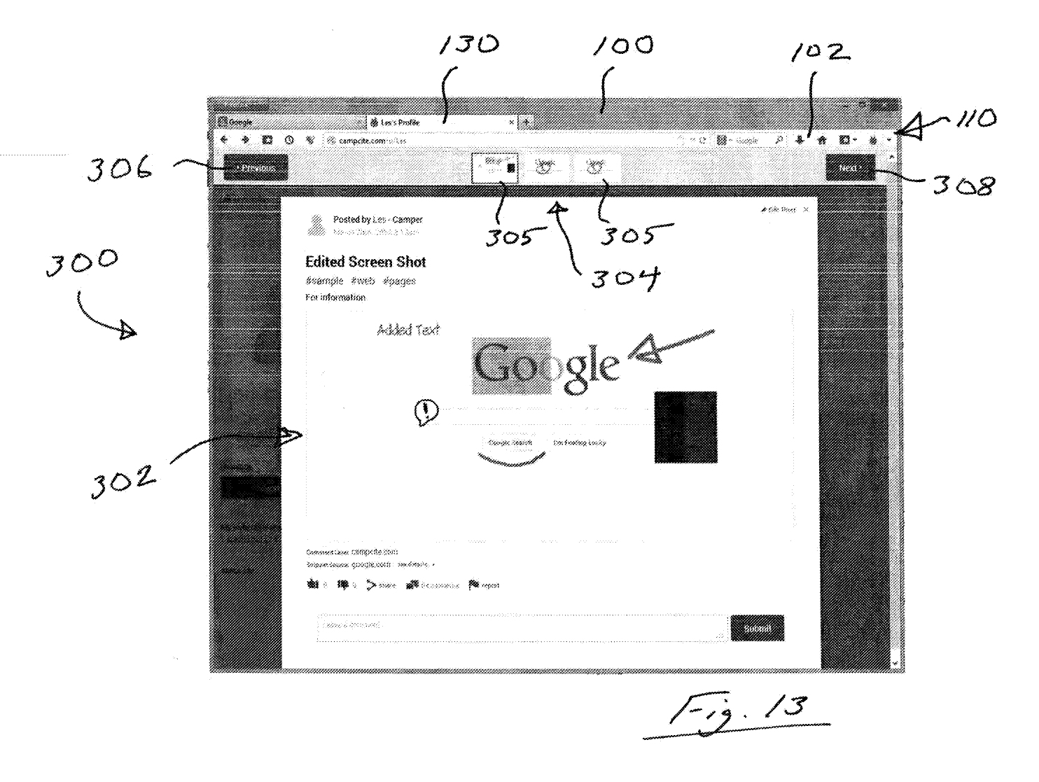

FIG. 10 is a user interface of a user editing screen displayed in a commentary service browser window of a personal device in accordance with the present invention. The user editing screen 250 can be displayed in a commentary service browser window of a personal device when the edit post button on the edited screenshot as-posted screen is actuated.

The user editing screen 250 can include fillable information fields for the user to enter or modify information associated with the edited screenshot. The user editing screen 250 can include a title field 252 for editing the title of the edited screenshot, a tag field 254 for editing tags to be used in indexing the edited screenshot, and a comment post field 256 for editing comments related to the edited screenshot. The user editing screen 250 can also include a listing settings box 258 to edit the accessibility of the edited screenshot, i.e., whether the edited screenshot is to be public, semi-private (available to selected users), or private (available only to the user creating the edited screenshot). The user editing screen 250 can also include a community selection box 260 to edit in which communities within the commentary service the edited screenshot is to be posted. The user editing screen 250 can also include a graphic image of the edited screenshot 262, a submit button 264 to allow the user to save the edited information on the user editing screen 250, and a delete button 2662 allow the user to delete the posted edited screenshot if desired.

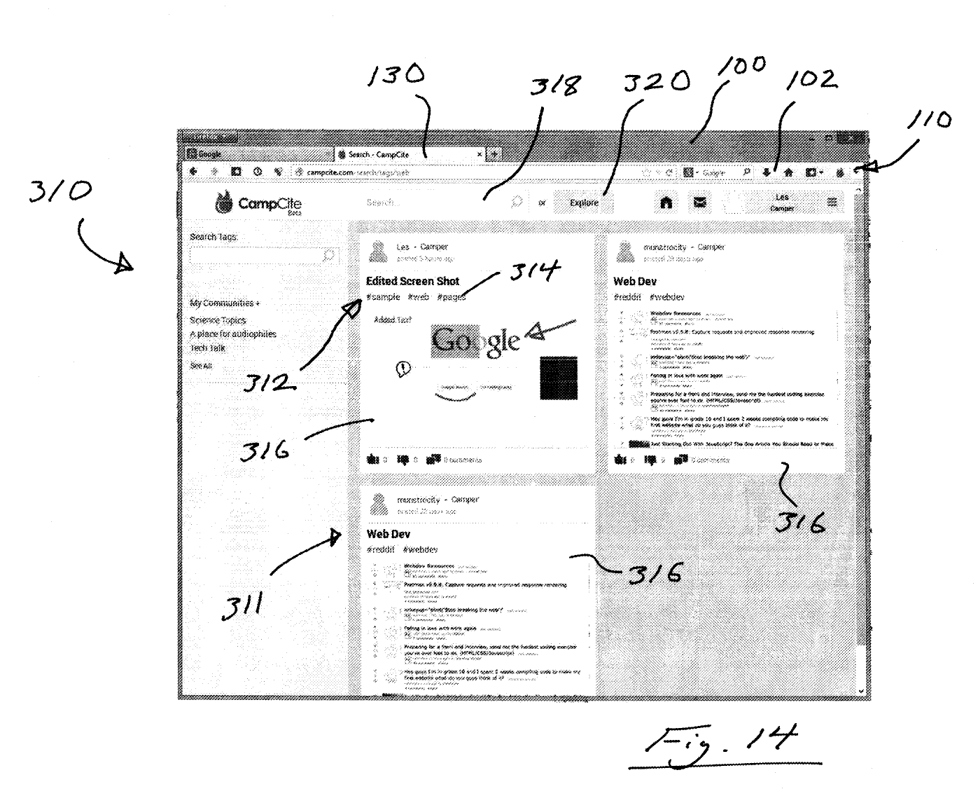

FIG. 11 is a user interface of a user home screen displayed in a commentary service browser window of a personal device in accordance with the present invention. Once the user has signed and with the commentary service, the user can access the user home screen 270 by actuating the commentary service logo button 272, the home button 274, the commentary service add-in button 110, or a home feed selection in the drop-down index box 276. The user home screen 270 can include a multiple display portion 271, which displays a number of edited screenshots 280 that are stored in the commentary service remote storage. The edited screenshots 280 can be sorted out as desired by the user, using a screenshot sort selection box 290, which can include sort options such as most recent, most popular, most changed, or the like. The user home screen 270 can also include a trending tag display 292, which displays tags associated with edited screenshots that are stored in the commentary service remote storage and are most active, i.e., being most added and/or accessed by users within the commentary service. Actuating one of the tags within the trending tag display 292 displays a tag search screen with edited screenshots labeled with the actuated tag, e.g., actuating a #yahoo tag displays a #yahoo tag search screen with edited screenshots labeled with #yahoo. The user home screen 270 can also include a user community display 294, which displays communities to which the user is subscribed. Actuating one of the community names within the user community display 294 displays a community home screen with edited screenshots for the actuated community name, e.g., actuating a Science Topics community name displays a Science Topics community home screen with edited screenshots posted to the Science Topics community.

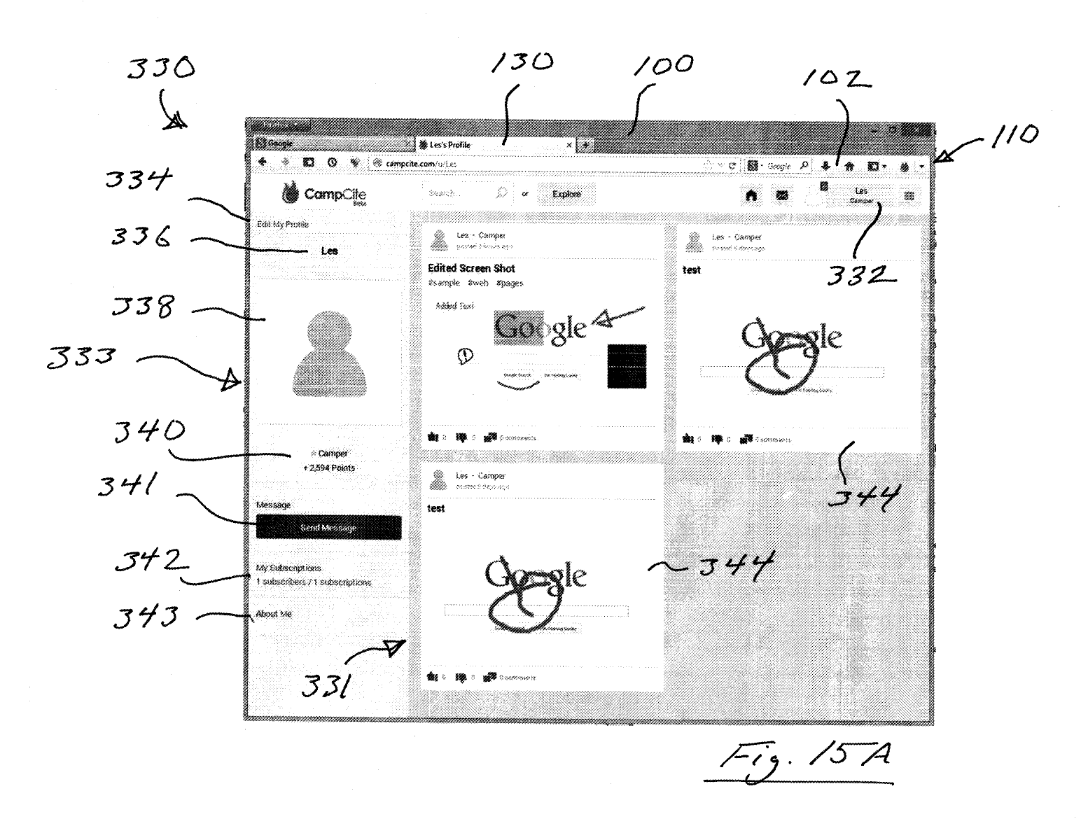

FIG. 12 is a user interface detail view of a drop-down index box displayed in a commentary service browser window of a personal device in accordance with the present invention. Actuating the drop-down index box 276 displays a user option drop-down box 278 listing user options 279. Actuating one of the user options 279 shifts the user interface in the commentary service browser window to the particular user option selected, e.g., actuating the Home Feed user option displays the user home screen.

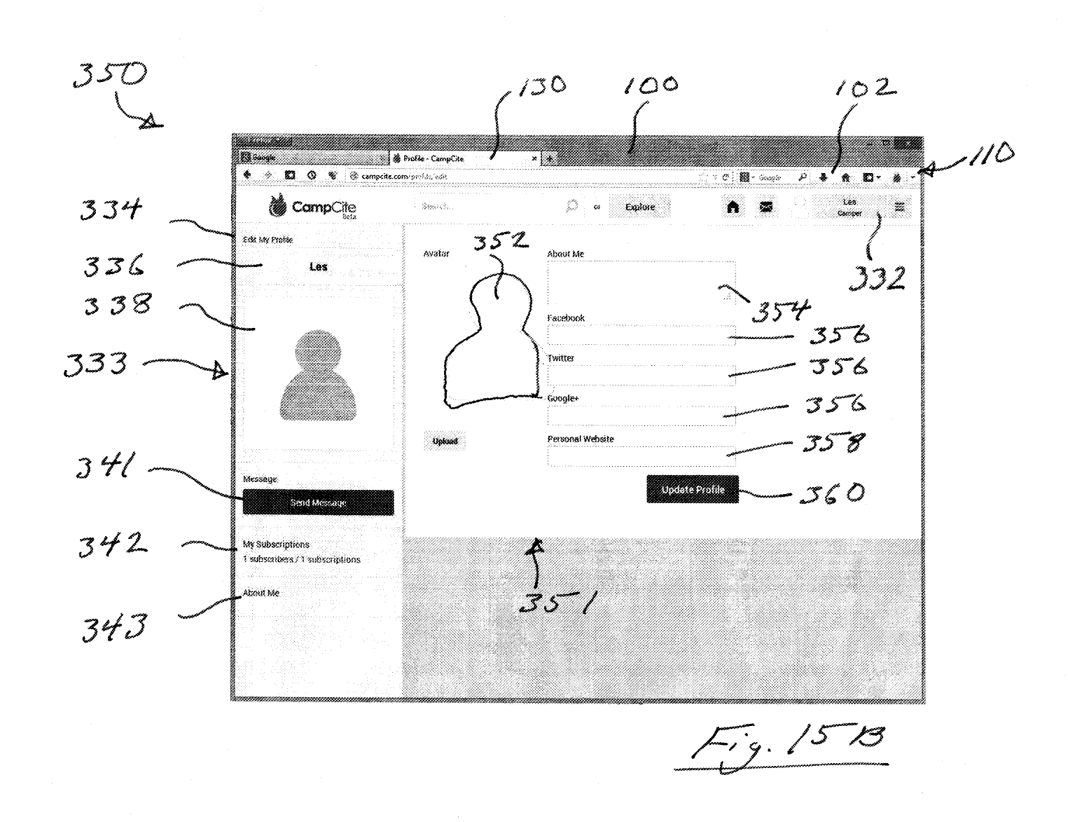

FIG. 13 is a user interface of a single edited screenshot screen displayed in a commentary service browser window of a personal device in accordance with the present invention. Actuating one of the edited screenshots in a multiple edited screenshot screen, such as clicking on one of the edited screenshots 280 in the multiple display portion 271 of the user home screen 270 as illustrated in FIG. 11. Those skilled in the art will appreciate that the single edited screenshot screen can be displayed by actuating any one of the edited screenshots in a multiple edited screenshot screen as desired for a particular application. In one embodiment, the single edited screenshot screen is overlaid on the multiple edited screenshot screen.

Referring to FIG. 13, the single edited screenshot screen 300 displays the single edited screenshot 302. The single edited screenshot screen 300 can also include a thumbnail display 304 with thumbnails 305 of the edited screenshots from the previous multiple edited screenshot screen. The single edited screenshot 302 displayed can be switched with the other edited screenshots from the previous multiple edited screenshot screen by actuating one of the thumbnails 305, or by use of the previous button 306 or next button 308 which displays an adjacent one of the edited screenshots from the previous multiple edited screenshot screen.

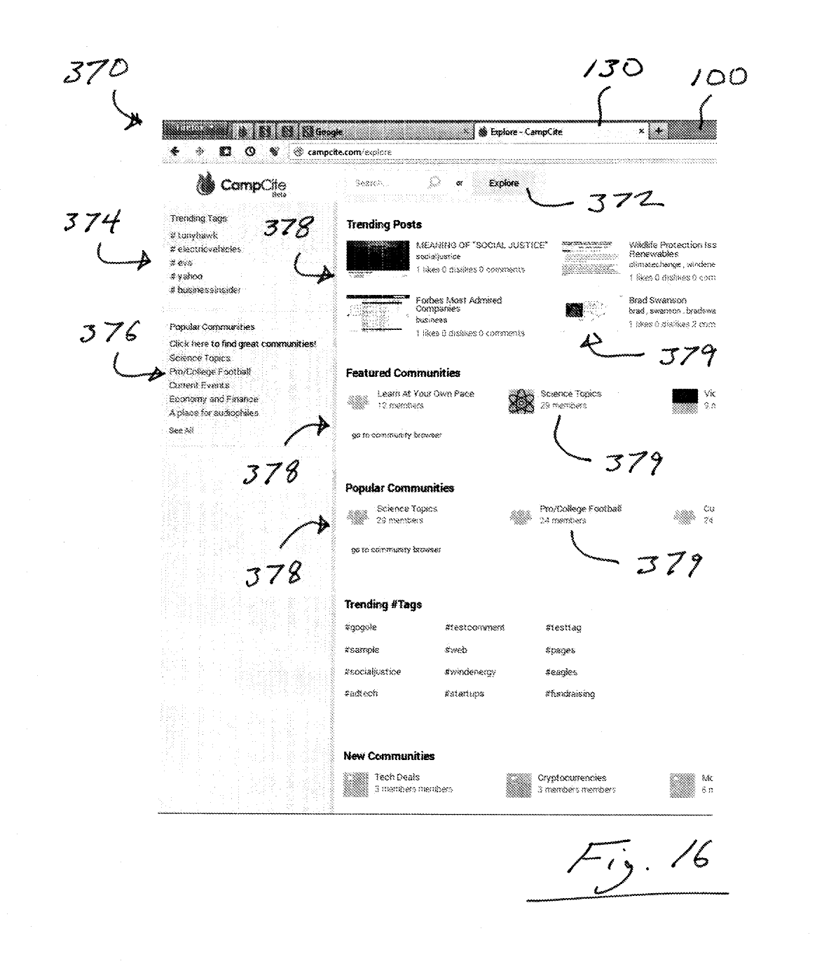

FIG. 14 is a user interface of a tag search results screen displayed in a commentary service browser window of a personal device in accordance with the present invention. The tag search results screen 310 displays edited screenshots stored on the commentary service remote storage which are indexed to the searched tag and to which the user has access.

In one embodiment, actuating a displayed tag anywhere within the commentary service will display the tag search results screen 310. For example, actuating an edited screenshot tag button 314 on a tag list 312 of an edited screenshot 316 in a multiple display portion 311 of a tag search results screen 310 will display a tag search results screen 310. In the example of FIG. 14, the #web screenshot tag button 314 was actuated to generate the tag search results screen 310, which includes edited screenshots 316 with tags including #web. In another embodiment, the an edited screenshot tag can be entered in the search field 318 and a search performed to generate and display the tag search results screen 310. In yet another embodiment, an explore button 320 can be actuated to display an explore screen with one or more listings of edited screenshot tags currently in use, which can be actuated to display a tag search results screen.

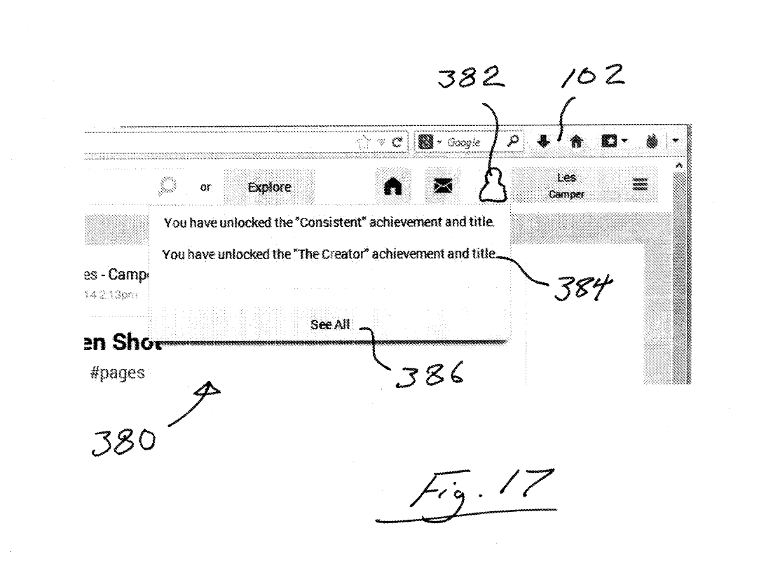

FIGS. 15A & 15B are a user interface of a user profile screen and a user profile edit screen, respectively, displayed in a commentary service browser window of a personal device in accordance with the present invention. The user profile screen 330 displays posts of edited screenshots from and information about the user of the commentary service. The user profile edit screen 350 allows editing of the information about the user of the commentary service.

Referring to FIG. 15A, actuating the user button 332 displays the user profile screen 330. The multiple display portion 331 of the user profile screen 330 displays edited screenshot 344 posted by the user. The user information portion 333 of the user profile screen 330 displays information about the user, such as username 336, user avatar 338, user commentary service rating 340, send message link 341, user subscription listing 342 and/or user description 343. The user information portion 333 can also include a profile edit button 334.

Referring to FIG. 15B, actuating the profile edit button 334 displays the profile edit screen 350. A profile edit portion 351 of the profile edit screen 350 can include input fields for a user description 354, social media addresses 356, and/or a personal website address 358. The profile edit portion 351 can also include an avatar display 352 into which a graphical user avatar can be uploaded from a file. The profile edit portion 352 can also include an update profile button 360 which, when actuated, saves the user information to the commentary service remote storage.

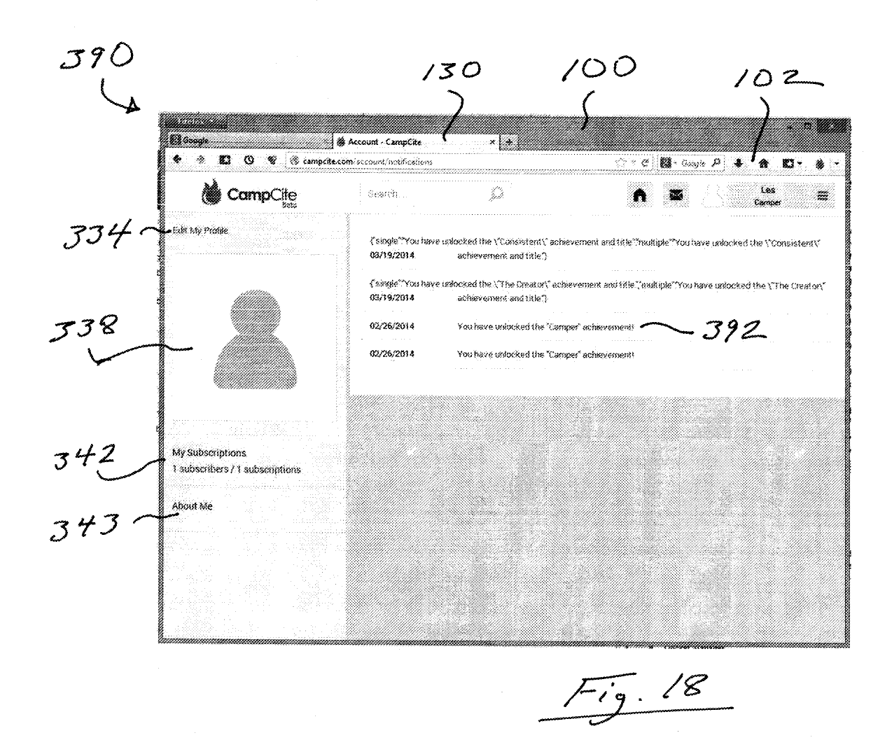

FIG. 16 is a user interface of an explore screen displayed in a commentary service browser window of a personal device in accordance with the present invention. Actuating the explore button 372 displays the explore screen 370. The explore screen 370 can include lists, such as a trending tag list 374 which includes tags indicating the most activity on the commentary service and a popular community list 376 which includes communities on the commentary service having the greatest number of members. The explore screen 370 can also include topic groups 378 organized by topics such as trending posts, featured communities, popular communities, pending #tags, new communities, and the like. Topics 379 within the topic groups 378 can include graphics and additional information related to the particular topic listed.

Those skilled in the art will appreciate that ordering of content, such as tags, websites, communities, and the like, inside of and external to the commentary service can be measured as desired for a particular application for presentation and filtering of content. In one example, content can be ordered by the most active, i.e., being most added and/or accessed by users. In another example, content can be ordered by most popular, i.e., being most voted for and/or least voted against. In yet another example, content can be ordered by most highly rated, i.e., receiving highest numerical/starred user ratings. In yet another example, content can be ordered by expert rating, i.e., receiving highest numerical/starred ratings from general or subject matter experts. In one embodiment, the ordering of content can be used in presenting lists of content items, such as trending tag lists. In another embodiment, the user can use the ordering of content as a filter for presentation of search results when performing a search.

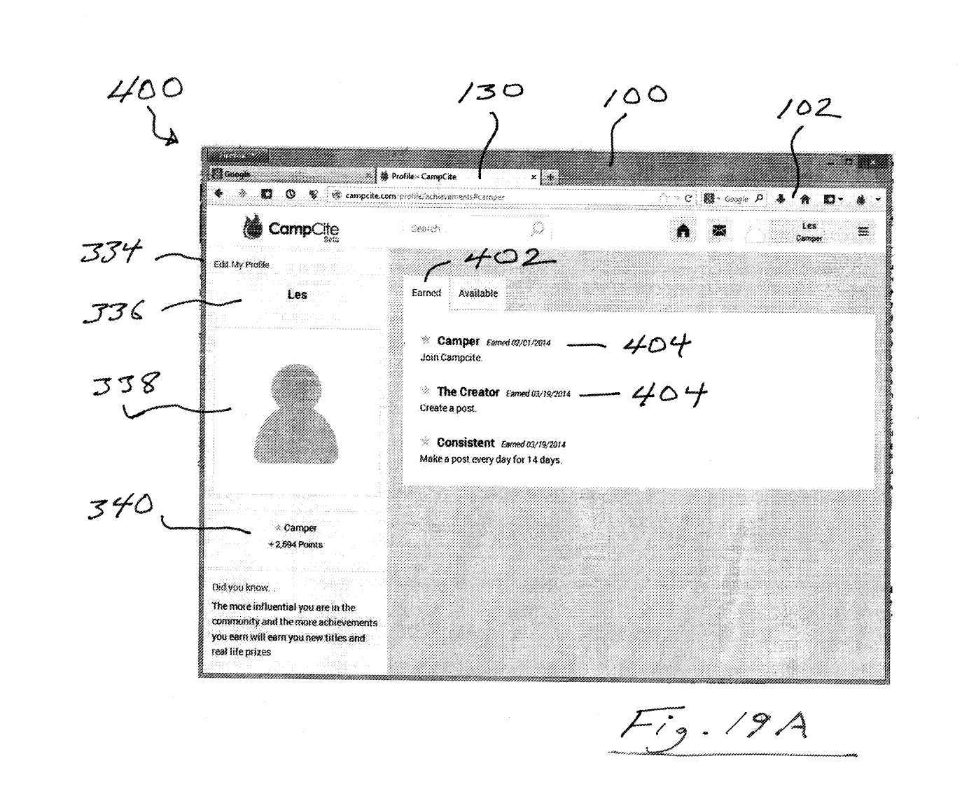

FIG. 17 is a user interface of user account drop-down list displayed in a commentary service browser window of a personal device in accordance with the present invention. Actuating the user avatar button 382 displays the user account drop-down list 380, which includes a list of achievement messages 384 concerning user achievements. The user account drop-down list 380 can also include See All button 386 which, when actuated, displays a user account history screen.

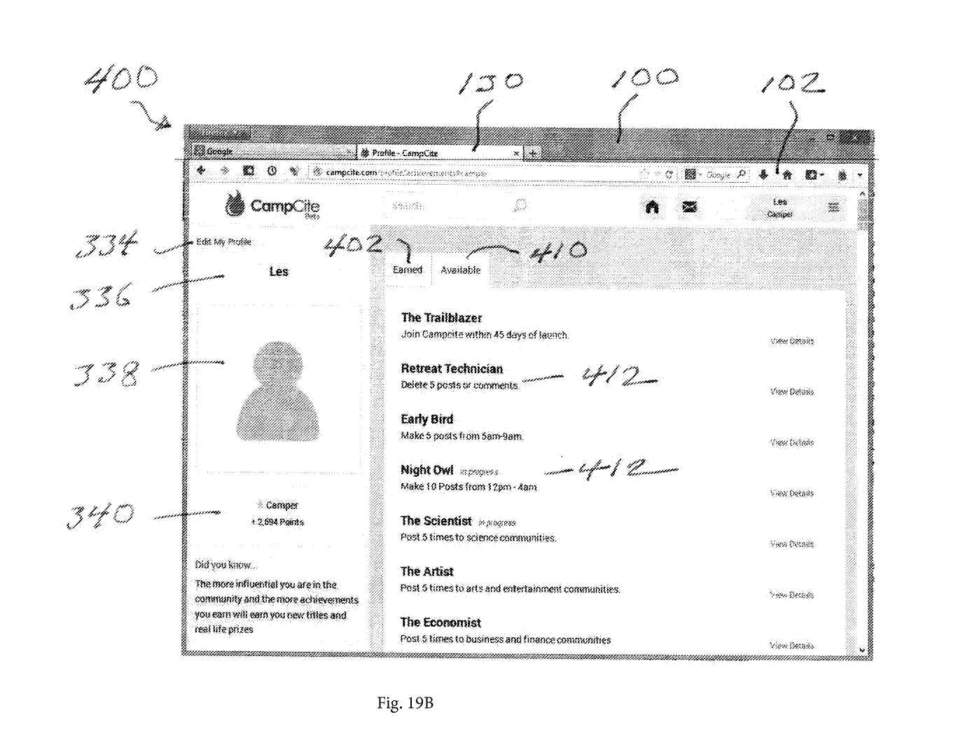

FIG. 18 is a user interface of user account history screen displayed in a commentary service browser window of a personal device in accordance with the present invention. Actuating the See All button on a user account drop-down list displays the user account history screen 390. The user account history screen 390 includes a list of user achievement messages 392, such as the date, particular achievement reach, and the like. Actuating a user achievement message 392 can display a user account profile screen.

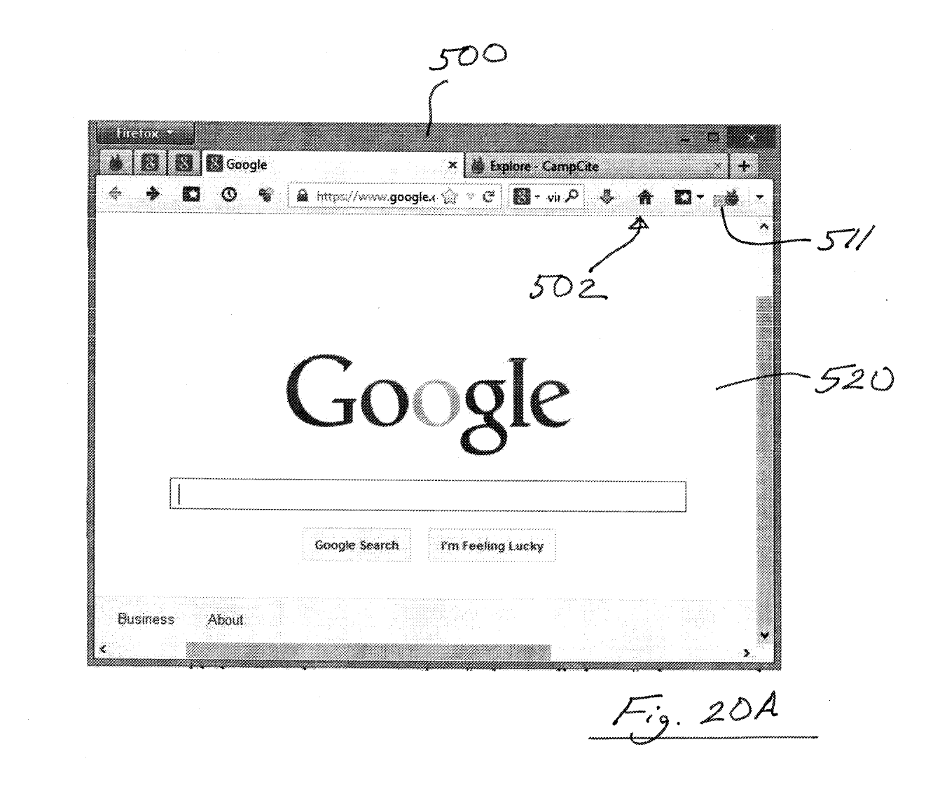

FIGS. 19A & 19B are a user interface of an earned accomplishments tab and a potential accomplishments tab, respectively, of a user account profile screen displayed in a commentary service browser window of a personal device in accordance with the present invention. Actuating a user achievement message on a user account history screen can display a user account profile screen 400. Referring to FIG. 19A, the earned accomplishments tab 402 on the user account profile screen 400 includes achievement items 404 obtained by the user, including information such as an achievement title, date earned, achievement details, and the like. Referring to FIG. 19B, the potential accomplishments tab 410 on the user account profile screen 400 includes potential achievement items available to the user, including information such as an achievement title, achievement requirements, and the like. The user account profile screen 400 can be toggled between the earned accomplishments tab 402 and the potential accomplishments tab 410 by actuating the tab which is not displayed.

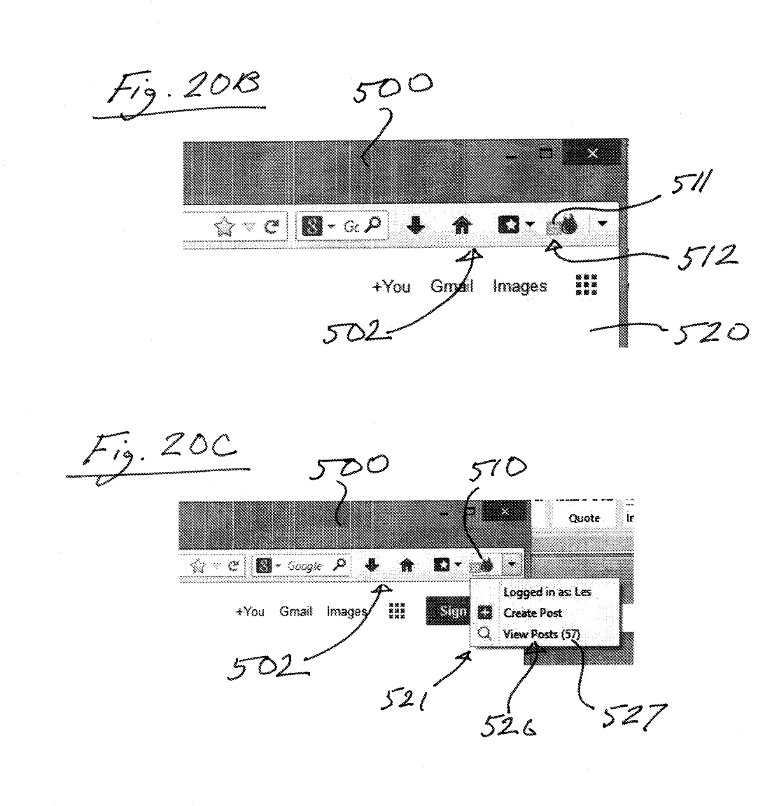

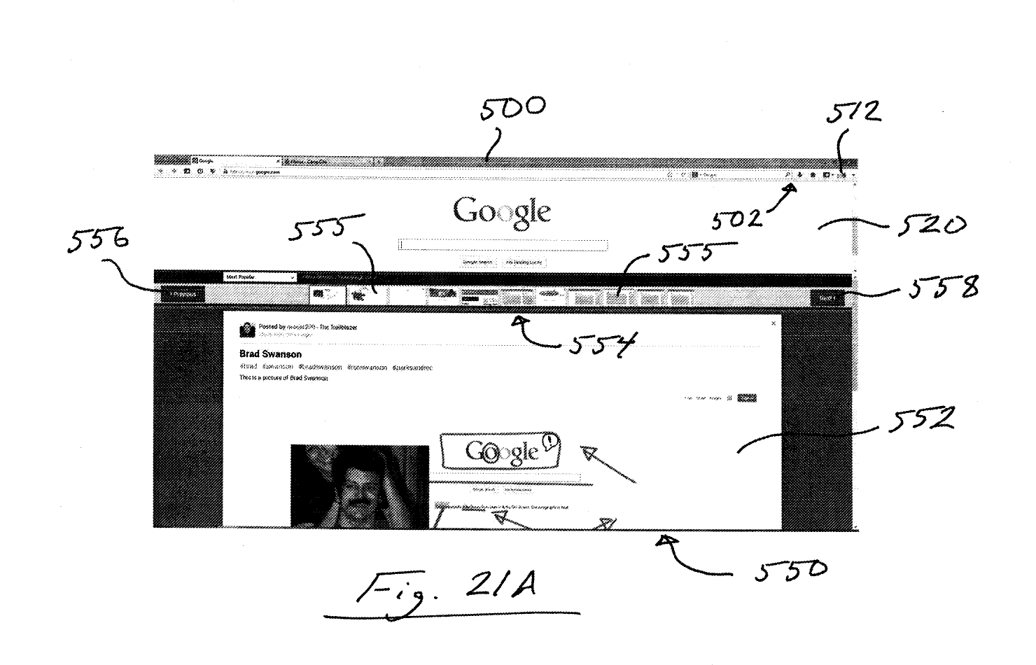

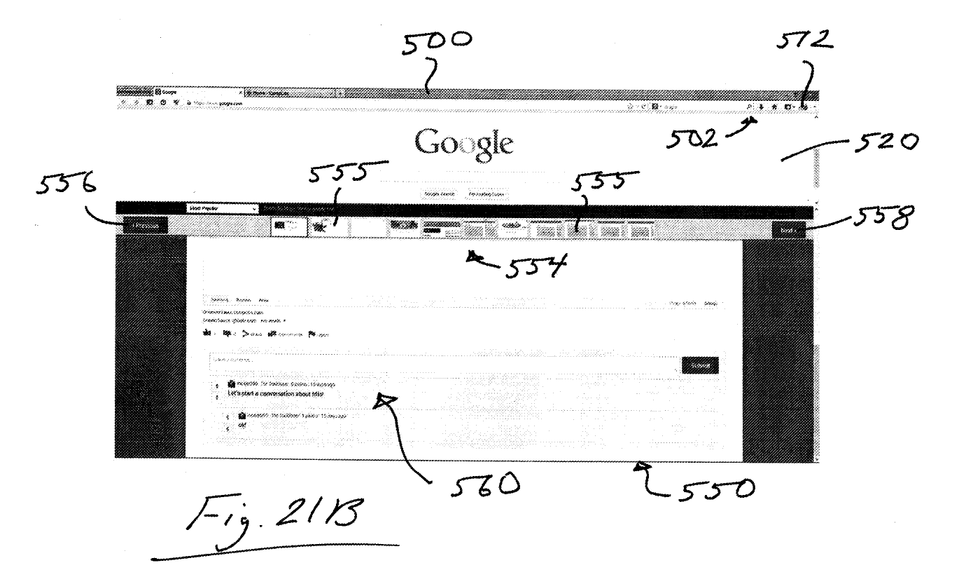

FIGS. 20A-20C are user interfaces of a website displayed in a web browser of a personal device in accordance with the present invention. In this example, the web browser 500 is the Firefox web browser open on a personal device (not shown). Referring to FIG. 20A, an Annotation indicator 511 is displayed on the navigation toolbar 502 of the web browser 500. The website 520 in this example is the homepage for the Google website at www.Google.com.

FIG. 20B illustrates detail of the Annotation indicator 511 displayed in the web browser 500, which indicates existence of an edited screenshot associated with the website and stored on the commentary service remote storage. In this example, the Annotation indicator 511 includes an edited screenshot counter 512 which indicates the number of edited screenshot associated with the website. In this example, the edited screenshot counter 512 displays the number 57 corresponding to 57 edited screenshots associated with the website stored on the commentary service remote storage. In one embodiment, the Annotation indicator 511 can function as a commentary service Show Annotation button when actuated to retrieve edited screenshot from the service remote storage and to display the edited screenshots associated with the website in the web browser.

FIG. 20C illustrates detail of a drop-down box 521 displayed in the web browser 500 when a commentary service add-in button 510 is actuated. The drop-down box 521 includes a commentary service Show Annotation button 526 with an edited screenshot counter 527, which indicates the number of edited screenshots associated with the website. In this example, the edited screenshot counter 527 displays the number 57 corresponding to 57 edited screenshots associated with the website stored on the commentary service remote storage. When actuated, the commentary service Show Annotation button 526 can retrieve one or more of the edited screenshots from commentary service remote storage and display one or more of the edited screenshots in the web browser 500.

FIGS. 21A & 21B are a user interface of an edited screenshot screen displayed in a web browser of a personal device in accordance with the present invention. Actuating a commentary service Show Annotation button, which can be a function of the edited screenshot counter 512, displays the edited screenshot screen 550 in the web browser 500. In this embodiment, the edited screenshot screen 550 is overlaid on the website 520, which remains functional, so that the website 520 and the edited screenshot 552 appear in different frames. In another embodiment, the edited screenshot screen can completely cover the website.

Referring to FIG. 21A, the edited screenshot screen 550 displays in edited screenshot 552. The edited screenshot screen 550 can also include a thumbnail display 554 with thumbnails 555 of additional edited screenshots associated with the website 520. The edited screenshot screen 550 displayed can be switched with the other edited screenshots associated with the website 520 by actuating one of the thumbnails 555, or by use of the previous button 556 or next button 558 which displays an adjacent one of the edited screenshots associated with the website 520. FIG. 21B illustrates the edited screenshot screen 550 with the edited screenshot 552 scrolled down to display the edited screenshot conversation 560 posted by users.

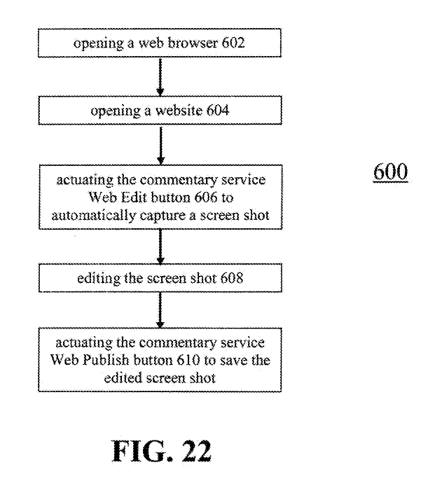

FIG. 22 is a flowchart for a method of annotating webpages from a personal device in accordance with one embodiment of the present invention. The method 600 can operate on a system as illustrated in FIG. 1.

Referring to FIG. 22, the method 600 can include opening a web browser 602 on the personal device, the web browser including a commentary service Web Edit button; and opening a website 604 in the web browser. Exemplary personal devices include personal computers, tablet computers, portable computers, and smart phones, and the like. Actuating the commentary service Web Edit button 606: to automatically capture a screenshot of the opened website; to open a commentary service browser window in the web browser, the commentary service browser window including editing tools and a commentary service Web Publish button; and to display the automatically captured screenshot in the opened commentary service browser window.

The method 600 can continue with editing the screenshot 608 with the editing tools within the commentary service browser window to generate an edited screenshot; and actuating the commentary service Web Publish button 610 to save the edited screenshot associated with the website to commentary service remote storage, the commentary service remote storage being remote from the personal device. The editing the screenshot 608 can take place at a location as desired for a particular application, i.e., the user can input changes/additions to a screenshot displayed on the personal device, but the changes to the screenshot are made at the personal device or the commentary service remote server. In one embodiment, the editing the screenshot 608 with the editing tools includes editing the screenshot with the editing tools on a commentary service remote server. In another embodiment, the editing the screenshot 608 with the editing tools includes editing the screenshot with the editing tools on the personal device. Exemplary editing tools include cropping tools, pen tools, highlight tools, figure tools, text tools, color selection tools, image selection tools, reverse action tools, repeat action tools, and the like. In one embodiment, the method 600 can further include displaying the website in the web browser after actuating the commentary service Web Publish button 610.

The edited screenshot can include various elements and the further processed. In one embodiment, the edited screenshot includes graphical elements and text elements. In another embodiment, when the edited screenshot includes graphical elements, the method 600 can further include obtaining optical character recognition text elements from graphical text within the graphical elements.

The method 600 can further include adding comments to the edited screenshot associated with the website. The comments can be text, images, sound, or a combination thereof. In one embodiment, adding comments can include adding comments from a personal or public comment library. In one example, comments can be added from a personal comment library of stored replies, i.e., replies which the user has found popular or persuasive in past commenting and has stored in the personal comment library for future use. In another example, comments can be added from a public comment library of popular replies, such as a library of replies voted as popular from past use in comments on the commentary service.

Adding comments can employ an argument assist tool for assistance to the user. In one embodiment, adding comments can include adding logically valid comments based on input from an argument assist tool, which can consist of tools such as neural net tools, rule set tools, and the like. In one embodiment, the argument assist tool can employ rules such as the legal rules of evidence, scientific methods, logic, rhetoric, and the like. In another embodiment, the argument assist tool analyzes prior comments associated with the edited screenshot to formulate the logically valid comments. In another embodiment, the argument assist tool can include a user searchable index of artifacts, such as axioms, maxims, aphorisms, proverbs, rules, principles, arguments (e.g., ad hominem), counter arguments, fallacies, laws, or the like, which can be used in formulating the logically valid comments.

The web browser can be prepared prior to opening the web browser 602 on the personal device. In one embodiment, the method 600 can further include registering with a commentary service linked to the commentary service Web edit button prior to the opening a web browser on the personal device. In another embodiment, the method 600 can further include installing a commentary service browser extension to the web browser before the opening a web browser on the personal device, the commentary service browser extension including computer code operable to display and enable the commentary service Web Edit button, the editing tools, and the commentary service Web Publish button in the web browser.

The method 600 can also include opening a second web browser on a second personal device; opening the website in the second web browser; indicating existence of the edited screenshot associated with the website on an Annotation indicator on the second web browser; and actuating a commentary service Show Annotation button on the second web browser: to retrieve the edited screenshot from the service remote storage; and to display the retrieved edited screenshot in the web browser. In one embodiment, the retrieved edited screenshot is displayed in the second web browser as an overlay to the website. In one embodiment, the second web browser is the same as the prior web browser and/or the second personal device is the same as the prior personal device. In another embodiment, the second web browser is different than the prior web browser and/or the second personal device is different than the prior personal device.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method of annotating webpages from a personal device, the method comprising:
opening a web browser on the personal device, the web browser including a commentary service Web Edit button;
opening a website in the web browser;
actuating the commentary service Web Edit button:
to automatically capture a screenshot of the opened website;
to open a commentary service browser window in the web browser, the commentary service browser window including editing tools and a commentary service Web Publish button; and
to display the automatically captured screenshot in the opened commentary service browser window;
editing the screenshot with the editing tools within the commentary service browser window to generate an edited screenshot; and
actuating the commentary service Web Publish button to save the edited screenshot associated with the website to commentary service remote storage, the commentary service remote storage being remote from the personal device.

2. The method of claim 1 wherein the personal device is a first personal device and the web browser is a first web browser, the method further comprising:
opening a second web browser on a second personal device;
opening the website in the second web browser;
indicating existence of the edited screenshot associated with the website on an Annotation indicator on the second web browser; and
actuating a commentary service Show Annotation button on the second web browser:
to retrieve the edited screenshot from the commentary service remote storage; and
to display the retrieved edited screenshot in the second web browser.

3. The method of claim 2 wherein the retrieved edited screenshot is displayed in the second web browser as an overlay to the website.

4. The method of claim 1 wherein the editing the screenshot with the editing tools comprises editing the screenshot with the editing tools on a commentary service remote server.

5. The method of claim 1 further comprising adding comments to the edited screenshot associated with the website.

6. The method of claim 5 wherein the adding comments comprises adding comments from a personal comment library of stored replies.

7. The method of claim 5 wherein the adding comments comprises adding comments from a public comment library of popular replies.

8. The method of claim 5 wherein the adding comments comprises adding logically valid comments based on input from an argument assist tool.

9. The method of claim 8 wherein the argument assist tool consists of tools selected from the group consisting of a neural net tool and a rule set tool.

10. The method of claim 8 wherein the argument assist tool employs rules selected from the group consisting of legal rules of evidence, scientific methods, logic, and rhetoric.

11. The method of claim 8 wherein the argument assist tool analyzes prior comments associated with the edited screenshot to formulate the logically valid comments.

12. The method of claim 8 wherein the argument assist tool includes a user searchable index of artifacts selected from the group consisting of axioms, maxims, aphorisms, proverbs, rules, principles, arguments, counter arguments, fallacies, and laws.

13. The method of claim 1 wherein the personal device is selected from the group consisting of a personal computer, a tablet computer, a portable computer, and a smart phone.

14. The method of claim 1 further comprising registering with a commentary service linked to the commentary service Web edit button prior to the opening a web browser on the personal device.

15. The method of claim 1 further comprising installing a commentary service browser extension to the web browser before the opening a web browser on the personal device, the commentary service browser extension including computer code operable to display and enable the commentary service Web Edit button, the editing tools, and the commentary service Web Publish button in the web browser.

16. The method of claim 1 wherein the editing tools are selected from the group consisting of a cropping tool, pen tool, highlight tool, figure tool, text tool, color selection tool, image selection tool, reverse action tool, and repeat action tool.

17. The method of claim 1 wherein the edited screenshot includes graphical elements and text elements.

18. The method of claim 1 wherein the edited screenshot includes graphical elements, the method further comprising obtaining optical character recognition text elements from graphical text within the graphical elements.

19. The method of claim 1 further comprising displaying the website in the web browser after the actuating the commentary service Web Publish button.

20. A device for annotating webpages with user input, the device comprising:
a user interface for receiving the user input;
a processor coupled to the user interface; and
a memory coupled to the processor, the memory containing programming code responsive to the user input to the user interface to:
open a web browser, the web browser including a commentary service Web Edit button;
open a website in the web browser;
automatically capture a screenshot of the opened website when the user input is actuation of the commentary service Web Edit button;
open a commentary service browser window in the web browser when the user input is the actuation of the commentary service Web Edit button, the commentary service browser window including editing tools and a commentary service Web Publish button;
display the automatically captured screenshot in the opened commentary service browser window when the user input is the actuation of the commentary service Web Edit button;
edit the screenshot with the editing tools within the commentary service browser window to generate an edited screenshot; and
save the edited screenshot associated with the website to commentary service remote storage when the user input is actuation of the commentary service Web Publish button, the commentary service remote storage being remote from the device.

21. The device of claim 20 wherein the memory contains further programming code responsive to the user input to the user interface to:
open the web browser;
open the website;
indicate existence of the edited screenshot associated with the website on an Annotation indicator on the web browser;
retrieve the edited screenshot from the commentary service remote storage when the user input is actuation of a commentary service Show Annotation button on the web browser; and
display the retrieved edited screenshot in the web browser when the user input is the actuation of the commentary service Show Annotation button.

22. A system for annotating webpages, the system comprising:
commentary service remote storage; and
a personal device having a user interface to receive user input and being operably connected to communicate with the commentary service remote storage, the commentary service remote storage being remote from the personal device;
wherein the personal device is responsive to the user input to:
open a web browser, the web browser including a commentary service Web Edit button;
open a website in the web browser;
automatically capture a screenshot of the opened website when the user input is actuation of the commentary service Web Edit button;
open a commentary service browser window in the web browser when the user input is the actuation of the commentary service Web Edit button, the commentary service browser window including editing tools and a commentary service Web Publish button;
display the automatically captured screenshot in the opened commentary service browser window when the user input is the actuation of the commentary service Web Edit button;
edit the screenshot with the editing tools within the commentary service browser window to generate an edited screenshot; and
save the edited screenshot associated with the website to the commentary service remote storage when the user input is actuation of the commentary service Web Publish button.

23. The system of claim 22 wherein the personal device is further responsive to the user input to:
open the web browser;
open the website;
indicate existence of the edited screenshot associated with the website on an Annotation indicator on the web browser;
retrieve the edited screenshot from the commentary service remote storage when the user input is actuation of a commentary service Show Annotation button on the web browser; and
display the retrieved edited screenshot in the web browser when the user input is the actuation of the commentary service Show Annotation button.
